(19) United States
(12) Patent Application Publication
(10) Pub. No.: US 2016/0153367 A1
(43) Pub. Date: Jun. 2, 2016

(54) METHOD FOR DIAGNOSING DETERIORATION OF INTERCOOLER

(71) Applicants: Hyundai Motor Company, Seoul (KR); Kia Motors Corporation, Seoul (KR)

(72) Inventor: Sang Il YOON, Anyang-si (KR)

(73) Assignees: Hyundai Motor Company, Seoul (KR); Kia Motors Corporation, Seoul (KR)

(21) Appl. No.: 14/945,266

(22) Filed: Nov. 18, 2015

(30) Foreign Application Priority Data
Dec. 2, 2014 (KR) 10-2014-0170358

(51) Int. Cl. F02D 9/02; G01F 1/68; F02B 29/04

(52) U.S. Cl. CPC F02D 9/02; F02B 29/04; G01F 1/68; F02D 2009/0225

(57) ABSTRACT

A method for diagnosing deterioration of an intercooler may include determining whether an engine RPM, an engine rotating speed, an atmospheric temperature, and an atmospheric pressure are in a preset range, determining a deviation between a temperature detected by an intercooler outlet temperature sensor and a temperature detected by an air flow sensor when all of the engine RPM, the engine rotating speed, the atmospheric temperature, and the atmospheric pressure are determined to be in the preset range; and determining that the intercooler deteriorates when the determined deviation is determined to be equal to or more than a preset reference error value.

### CROSS-REFERENCE(S) TO RELATED APPLICATIONS

The present application claims priority of Korean Patent Application Number 10-2014-0170358 filed on Dec. 2, 2014, the entire contents of which application are incorporated herein for all purposes by this reference.

### BACKGROUND OF THE INVENTION

1. Field of the Invention

Exemplary embodiments of the present invention relate to a method for diagnosing deterioration of an intercooler, and more particularly, to a method for diagnosing deterioration of an intercooler capable of determining whether the intercooler deteriorates by comparing a temperature sensor at a latter stage of the intercooler with an atmospheric temperature.

2. Description of Related Art

To help understand the present invention, a general turbocharger and an intercooler will be described below.

Generally, in a vehicle in which the turbocharger is equipped, the intercooler for cooling air compressed by the turbocharger has been used.

The turbocharger compresses sucked air (external air) using a pressure of exhaust gas discharged through an exhaust manifold of an engine and supplies the compressed air to the intercooler. In this case, the intercooler effectively cools the sucked air of which the temperature rises while the turbocharger compresses the external air by using traveling wind and supplies the cooled air to the intake manifold of the engine, thereby improving an output and fuel efficiency of the engine and reducing exhaust gas and engine noise.

Further, a radiator is an apparatus which cools cooling water heated by the engine and is configured to generally include an upper tank, a lower tank, and a radiator core. When the cooling water of which the temperature rises passes through the radiator core, the radiator cools the cooling water using the traveling wind introduced at the time of driving of a vehicle and the external air introduced at the time of driving of the cooling fan.

That is, both of the radiator and the intercooler are a module cooling the vehicle using the traveling wind. Generally, the intercooler is disposed in front of a hood and the radiator and the cooling fan are disposed in back of the hood.

That is, when a temperature of intake air and a temperature of cooling water which are supplied to the engine are high, both of the radiator and the intercooler mounted at a latter stage of an engine fan are an apparatus which may reduce the temperature of intake air and the temperature of cooling water to be maintained at an appropriate level.

The following Patent Document 1 relates to a method for monitoring an intercooler, and more particularly, to a method for monitoring an intercooler using an outlet temperature of the intercooler when a vehicle is stably driven. This is to prevent an erroneous determination of a fault which is sensed due to a distortion of temperature when the vehicle is driven in an instable state. The following Patent Document 1 never considers an engine RPM or external driving conditions.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method for diagnosing deterioration of an intercooler capable of determining whether the intercooler deteriorates by comparing a temperature sensor at a latter stage of the intercooler with an atmospheric temperature.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof

In accordance with another embodiment of the present invention, a method for diagnosing an intercooler includes: determining whether an engine RPM, an engine rotating speed, an atmospheric temperature, and an atmospheric pressure are in a preset range; calculating a deviation between a temperature detected by an intercooler outlet temperature sensor and a temperature detected by an air flow sensor if it is determined that all of the engine RPM, the engine rotating speed, the atmospheric temperature, and the atmospheric pressure are in the preset range; and determining that the intercooler deteriorates if it is determined that the calculated deviation is equal to or more than a preset reference error value.

In the determining that the intercooler deteriorates, when a state in which the calculated deviation is equal to or more than the preset reference error value is maintained for a predetermined time, it may be determined that the intercooler deteriorates.

The method may further include: if it is determined that the intercooler deteriorates, turning on a warning light.

The method may further include: if it is determined that the intercooler deteriorates, limiting an output of a vehicle.

The temperature detected by the air flow sensor may be an atmospheric temperature detected by an atmospheric temperature sensor of the air flow sensor.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flow chart schematically illustrating a method for diagnosing deterioration of an intercooler according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DESCRIPTION OF SPECIFIC EMBODIMENTS

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Since exemplary embodiments of the present invention may be various modified and may have several forms, specific exemplary embodiments will be shown in the accompanying drawings and will be described in detail in the present specification or disclosure. However, it is to be understood that the present invention is not limited to specific exemplary embodiments, but includes all modifications, equivalents, and substitutions included in the spirit and the scope of the present invention.

Terms such as ‘first’, ‘second’, etc., may be used to describe various components, but the components are not to be construed as being limited to the terms. The terms are used only to distinguish one component from another component. For example, the ‘first’ component may be named the ‘second’ component and the ‘second’ component may also be similarly named the ‘first’ component, without departing from the scope of the present invention.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween. Other expressions describing a relationship between components, that is, “between”, “directly between”, “neighboring to”, “directly neighboring to” and the like, should be similarly interpreted.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, steps, numerals, operations, components, parts, or a combination thereof, but do not preclude the presence or addition of one or more other features, numerals, steps, operations, components, parts, or a combination thereof

Unless indicated otherwise, it is to be understood that all the terms used in the specification including technical and scientific terms have the same meaning as those that are understood by those who skilled in the art. It must be understood that the terms defined by the dictionary are identical with the meanings within the context of the related art, and they should not be ideally or excessively formally defined unless the context clearly dictates otherwise.

Hereinafter, exemplary embodiments of the present invention will be described in detail with reference to the accompanying drawings. Like reference numerals proposed in each drawing denote like components. Further, a subject of performance of the present invention may be a vehicle controller or a detailed controller, for example, an engine controller for each part which configures a vehicle.

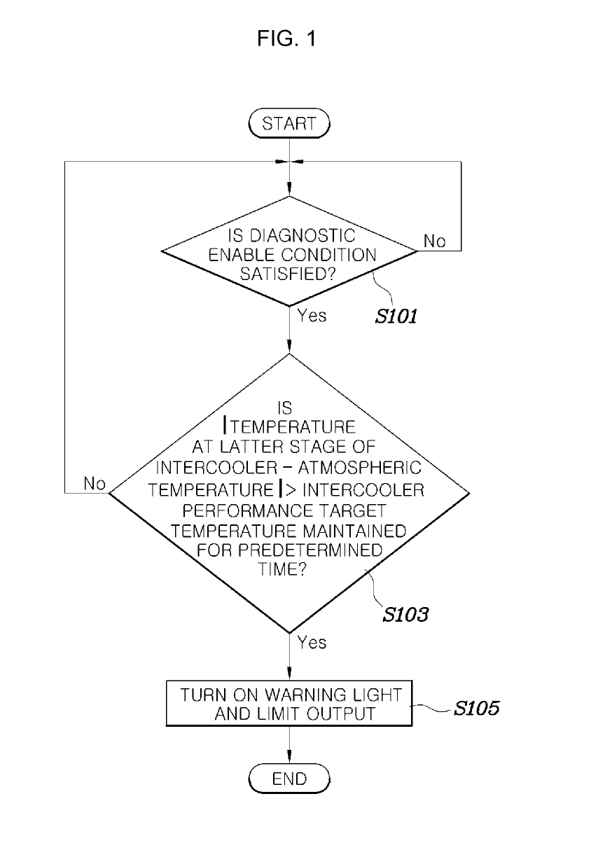

FIG. 1 is a flow chart schematically illustrating a method for diagnosing deterioration of an intercooler according to an exemplary embodiment of the present invention. The method for diagnosing deterioration of an intercooler according to the exemplary embodiment of the present invention includes determining whether a deterioration diagnostic enable condition is satisfied (S101) and if it is determined that the enable condition is satisfied, calculating a deviation between a temperature detected by an intercooler outlet temperature sensor and a temperature detected by an air flow sensor and determining whether a state in which the calculated deviation is equal to or more than a preset reference error value is maintained for a predetermined time (S103).

In detail, a deviation between a temperature detected by a temperature sensor at a latter stage of the intercooler and a temperature detected by an atmospheric temperature sensor of an air flow sensor which measures a sucked air temperature is calculated.

The method for diagnosing deterioration of an intercooler includes determining that the intercooler deteriorates to enable the vehicle controller to turn on a warning light or limit an output of a vehicle (S105) when the state in which the calculated deviation is equal to or more than the preset reference error value is maintained for a predetermined time.

In detail, a plurality of factors which configure the deterioration diagnostic enable conditions may include 1) current RPM of an engine, 2) atmospheric temperature, and 3) atmospheric pressure. That is, the method diagnoses the deterioration except for extreme situations such as a desert, a polar region, and a high land.

For example, only when all the conditions that the current RPM of an engine ranges from 1000 to 2800 rpm, the atmospheric temperature ranges from 7° to 35° below zero, and the atmospheric pressure is lower than that at the altitude of 2500 m are satisfied, the deviation between the temperature detected by the intercooler outlet temperature sensor and the temperature detected by the air flow sensor is calculated.

The reason why the state in which the calculated deviation is equal to or more than the preset reference error value is maintained for a predetermined time is to prevent erroneous diagnosis due to noise which may instantly occur by monitoring a change in temperature for a predetermined time.

According to the method for diagnosing an intercooler in accordance with the exemplary embodiment of the present invention, it is possible to improve the diagnostic accuracy by diagnosing the deterioration of the intercooler under the predetermined conditions.

Further, it is possible to suppress NOx and PM which may occur due to the deterioration of the intercooler by accurately diagnosing the deterioration of the intercooler.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. A method for diagnosing deterioration of an intercooler, comprising:
determining whether an engine RPM, an engine rotating speed, an atmospheric temperature, and an atmospheric pressure are in a preset range;
determining a deviation between a temperature detected by an intercooler outlet temperature sensor and a temperature detected by an air flow sensor when all of the engine RPM, the engine rotating speed, the atmospheric temperature, and the atmospheric pressure are determined to be in the preset range; and
determining that the intercooler deteriorates when the determined deviation is determined to be equal to or more than a preset reference error value.

2. The method of claim 1, wherein in the determining that the intercooler deteriorates, when a state in which the determined deviation is equal to or more than the preset reference error value is maintained for a predetermined time, the intercooler is determine to deteriorate.

3. The method of claim 1, further comprising:
when the intercooler is determined to deteriorate, turning on a warning light.

4. The method of claim 1, further comprising:
when the intercooler is determined to deteriorate, limiting an output of a vehicle.

5. The method of claim 1, wherein the temperature detected by the air flow sensor is an atmospheric temperature detected by an atmospheric temperature sensor of the air flow sensor.
